(19) United States
(12) Patent Application Publication
(10) Pub. No.: US 2024/0132148 A1
(43) Pub. Date: Apr. 25, 2024

(54) Method for Actuating an Electric Motor of a Pump Device of a Steering Device, Method for Providing a Correction Value for Correcting a Fluctuation of a Rotational Speed and/or an Output Pressure of a Pump Device of a Steering Device, Device, and Steering Device

(71) Applicant: KNORR-BREMSE SYSTEME FÜR NUTZFAHRZEUGE GMBH, München (DE)

(72) Inventor: Bernhard MILLER, Weil der Stadt (DE)

(21) Appl. No.: 18/277,603

(22) PCT Filed: Jan. 26, 2022
(86) PCT No.: PCT/EP2022/051753

§ 371 Date: Aug. 16, 2023

(30) Foreign Application Priority Data
Feb. 18, 2021 (DE) 10 2021 103 816.2

(51) Int. Cl. B62D 5/06; B62D 5/065; B62D 6/00

(52) U.S. Cl. CPC B62D 5/064; B62D 5/065; B62D 6/001

(57) ABSTRACT

A method is provided for actuating an electric motor of a pump device of a steering device, having a step of reading the current rotational angle of the electric motor of the pump device and a correction value which represents a relationship between an output pressure of the pump device and/or the rotational speed of the electric motor of the pump device on the basis of the rotational angle of the electric motor, and a step of outputting an actuation signal to the electric motor using the correction value.

### BACKGROUND AND SUMMARY

The present disclosure relates to a method for actuating an electric motor of a pump device of a steering apparatus, to a method for providing a correction value for correcting a variation in a rotational speed and/or an output pressure of a pump device of a steering apparatus, an apparatus and a steering apparatus.

In the case of steering systems of vehicles, in particular in the case of front axle steering systems (also called power steering system) of medium and heavy utility vehicles, a recirculating ball steering gear can be operated, for example, by way of an external, unidirectional hydraulic pump. A connection between the pump and the steering gear can take place, for example, by way of an external pipe system. In addition, an external oil reservoir can be required as equalizing vessel. Therefore, individual components of a steering system of this type can be arranged distributed in the vehicle.

DE 20 2019 101 522 U1 discloses a corresponding steering assistance apparatus for a vehicle, in particular for a utility vehicle.

Against this background, it is the object of the present disclosure to provide an improved method for actuating an electric motor of a pump device of a steering apparatus, an improved method for providing a correction value for correcting a variation in a rotational speed and/or an output pressure of a pump device of a steering apparatus, an improved apparatus and an improved steering apparatus.

This object is achieved by way of a method, by way of an apparatus, by way of a computer product, and by way of a steering apparatus, in accordance with the independent claims.

The advantages which can be achieved by way of the presented disclosure consist in that a detent torque in the steering apparatus is prevented or at least minimized.

To this end, a method for actuating an electric motor of a pump device of a steering apparatus is presented, the method comprising a step of reading in and a step of outputting. In the step of reading in, a current rotary angle of the electric motor of the pump device is read in and a correction value which represents a correlation of an output pressure of the pump device and, in addition or as an alternative, a rotational speed of the electric motor of the pump device in a manner which is dependent on the rotary angle of the electric motor. In the step of outputting, an actuating signal is output to the electric motor with use of the correction value.

The method can be used, for example, in a pump device of the steering apparatus as can be used in a utility vehicle, for example. Here, the steering apparatus is configured to assist a steering movement of a driver of the vehicle. The output pressure can indicate, for example, a pressure value of a fluid, or working medium, such as hydraulic oil, for example, which is pumped by a pump of the pump device. The rotary angle can indicate, for example, an angle, by which the electric motor rotates. The electric motor can be configured, for example, to drive a pump of the pump device. In the case of a variation, for example, the rotational speed of the electric motor can be adapted by way of the correction value such that steady operation of the electric motor is advantageously made possible.

In accordance with one embodiment, the correction value which is dependent on a rotational direction of the electric motor and, in addition or as an alternative, of the pump can be read in in the step of reading in. The rotational direction can run, for example, in the clockwise direction or counter to the clockwise direction, with the result that the pump can also pump the fluid correspondingly, for example.

In accordance with one embodiment, the correction value can be read in in the step of reading in, for the determination of which correction value the pressure, dependent on the rotary angle of the electric motor, of the pump device is linked to the rotational speed, dependent on the rotary angle of the electric motor, of the electric motor of the pump device. As a result, the electric motor can advantageously be actuated in such a way that variations in the rotational speed are avoided or at least reduced.

In accordance with one embodiment, the actuating signal can be output in the step of outputting with use of a current rotational speed of the electric motor and, in addition or as an alternative, a setpoint rotational speed of the electric motor. The electric motor can advantageously be actuated in such a way that, for example, it is energized to a greater or, as an alternative, lesser extent, in order to achieve the setpoint rotational speed and, for example, to run steadily.

In accordance with one embodiment, furthermore, at least one pressure which is output currently by the pump device and, in addition or as an alternative, at least one current rotational speed of the electric motor can be read in in the step of reading in. A correction value which is defined with use at least of the pressure currently output by the pump device and, in addition or as an alternative, the current rotational speed of the electric motor can be determined and stored in a step of determining and storing, in particular in order to be provided for a following step of reading in. As a result, a closed-loop or open-loop control operation of the rotational speed of the motor can advantageously be adapted dynamically to the operational environments.

In accordance with one embodiment, a plurality of pressure values which are output by the pump device and, in addition or as an alternative, a plurality of rotational speed values of the electric motor can be read in in the step of reading in. The correction value can be determined with use of averaging and, in addition or as an alternative, low pass filtering of the pressure values and, in addition or as an alternative, a plurality of rotational speed values of the electric motor in the step of determining. As a result, rotary angle-dependent friction of the pump of the pump device can advantageously be reduced.

In accordance with one embodiment, the correction value can be read in in the step of reading in, which correction value is defined from at least one characteristic diagram, in which a correlation of the output pressure of the pump device and, in addition or as an alternative, a rotational speed of the electric motor of the pump device is mapped in a manner which is dependent on a plurality of rotary angles of the electric motor. This means that the at least one characteristic diagram which maps an advantageous correlation between an output pressure of the pump device and/or a rotational speed of the motor or electric motor is advantageously stored.

Furthermore, a method for providing a correction value for correcting a variation in a rotational speed and, in addition or as an alternative, an output pressure of a pump device of a steering apparatus is presented, the method comprising a step of reading in and a step of determining. In the step of reading in, a rotary angle of the electric motor of the pump device and at least one pressure which is assigned to the rotary angle and is output by the pump device, and, in addition or as an alternative, at least one rotational speed, assigned to the rotary angle, of the electric motor are read in. In the step of determining and storing, a correction value which is defined with use of at least the pressure which is assigned to the rotary angle and, in addition or as an alternative, the rotational speed, assigned to the rotary angle, of the electric motor are determined.

The method can be carried out, for example, in order to feed the pump device of the steering apparatus, as can be used in utility vehicles, with necessary data which can advantageously serve as the basis in a method for actuating an electric motor in one of the abovementioned variants.

In accordance with one embodiment, a plurality of pressure values assigned to in each case one rotary angle and, in addition or as an alternative, a plurality of rotational speed values, assigned to in each case one rotary angle, of the electric motor can be read in in the step of reading in. Here, the correction value can be determined in the step of determining with use of averaging and, in addition or as an alternative, low pass filtering of the pressure values which are assigned to the respective rotary angles and, in addition or as an alternative, the rotational speed values, assigned to the respective rotary angles, of the electric motor. The averaging can be used, for example, as a start value for a dynamic adaptation of the correction values during operation of the electric motor. As a result, corresponding correction values can advantageously be assigned and stored in the characteristic diagram.

In accordance with one embodiment, at least one characteristic diagram can be defined in the step of determining, in which characteristic diagram the correction value is mapped as correlation of an output pressure of the pump device and, in addition or as an alternative, a rotational speed of the electric motor of the pump device in a manner which is dependent on in each case one rotary angle of the electric motor. Therefore, a plurality of characteristic diagrams can also advantageously be defined which can be applied in accordance with the starting pressure and, in addition or as an alternative, the rotational speed.

This method can be implemented, for example, in software or hardware or in a mixed form of software and hardware, for example in a control unit.

Furthermore, the concept presented here provides an apparatus which is configured to carry out, actuate or implement the steps of one variant of a method presented here in corresponding devices. This design variant of the concept in the form of an apparatus can also rapidly and efficiently achieve the object, on which the concept is based.

To this end, the apparatus can have at least one computing unit for processing signals or data, at least one storage unit for storing signals or data, at least one interface to a sensor or an actuator for reading in sensor signals from the sensor or for outputting data or control signals to the actuator, and/or at least one communications interface for reading in or outputting data which are embedded into a communications protocol. The computer unit can be, for example, a signal processor, a microcontroller or the like, it being possible for the storage unit to be a flash memory, an EPROM or a magnetic storage unit. The communications interface can be configured to read in or output data in a wireless and/or wired manner, it being possible for a communications interface which can read in or output wired data to read in these data, for example, electrically or optically from a corresponding data transmission line or to output them into a corresponding data transmission line.

In the present case, an apparatus can be understood to mean an electrical unit or a control unit which processes sensor signals and outputs control and/or data signals in a manner which is dependent thereon. The apparatus can have an interface which can be of hardware and/or software configuration. In the case of a hardware configuration, the interfaces can be, for example, part of what is known as a system ASIC which contains a very wide variety of functions of the apparatus. It is also possible, however, that the interfaces are dedicated, integrated circuits or consist at least partially of discrete components. In the case of a software configuration, the interfaces can be software modules which are present, for example, on a microcontroller in addition to other software modules.

In one advantageous refinement, a control operation of a method for actuating an electric motor of a pump device of a steering apparatus takes place by way of the apparatus. To this end, for example, the apparatus can access sensor signals such as a read-in signal which represents a current rotary angle of the electric motor of the pump device and a correction value, and can also access an actuating signal for actuating the electric motor. The actuation takes place via actuators such as a read-in unit which is configured to read in the read-in signal, and an actuating unit which is configured to output the actuating signal.

Furthermore, a steering apparatus for a vehicle is presented, which steering apparatus has a pump device, a transmission device and a control unit. Here, the pump device has a pump for pumping a working medium to a first output connector or, as an alternative, a second output connector, an electric motor for driving the pump, and a housing, through which the first output connector and the second output connector are routed and which is arranged around the pump and the electric motor. The transmission device has an input shaft which can be coupled to a steering wheel, and an output shaft which can be coupled to a steering column lever, a transmission element which can be moved in a first direction and a second direction in order to transmit a torque from the input shaft to the output shaft, and a first working medium connector and a second working medium connector, the first working medium connector being connected to the first output connector in order to move the transmission element with use of the working medium in the first direction, and the second working medium connector being connected to the second output connector in order to move the transmission element with use of the working medium in the second direction. The control unit is configured to provide a motor signal to the electric motor, in order to operate the electric motor of the steering apparatus. For example, the control unit can be configured as one variant of an apparatus presented here.

The steering apparatus can be used, for example, for a utility vehicle, in order to assist a steering movement of a driver of the vehicle. The pump device can be configured, for example, in such a way that one of the methods in one of the presented variants can be carried out. Furthermore, the pump of the pump device can be realized as a gear pump, for example.

In accordance with one embodiment, the steering apparatus in the abovementioned variant can have a valve which is connected between the first output connector and the second output connector. The valve can be realized, for example, as a back-up valve which can be configured to open in an emergency situation, for example.

Exemplary embodiments of the concept presented here will be explained in greater detail in the following description with reference to the figures.

### BRIEF DESCRIPTION OF THE DRAWINGS

FIG. 1 is a diagrammatic illustration of a vehicle with a steering apparatus in accordance with one exemplary embodiment;

FIG. 2 is a block circuit diagram of an apparatus for carrying out a method for actuating an electric motor of a pump device of a steering apparatus in accordance with one exemplary embodiment;

FIG. 3 is a block circuit diagram of an apparatus for carrying out a method for actuating an electric motor of a pump device of a steering apparatus in accordance with one exemplary embodiment;

FIG. 4 is a flow diagram of a method for actuating an electric motor of a pump device of a steering apparatus in accordance with one exemplary embodiment; and

FIG. 5 is a flow chart of a method for providing a correction value for correcting a variation in a rotational speed and/or an output pressure of a pump device of a steering apparatus in accordance with one exemplary embodiment.

In the following description of favorable exemplary embodiments of the present concept, identical or similar designations are used for the elements which are shown in the different figures and have a similar action, a repeated description of these elements being dispensed with.

### DETAILED DESCRIPTION OF THE DRAWINGS

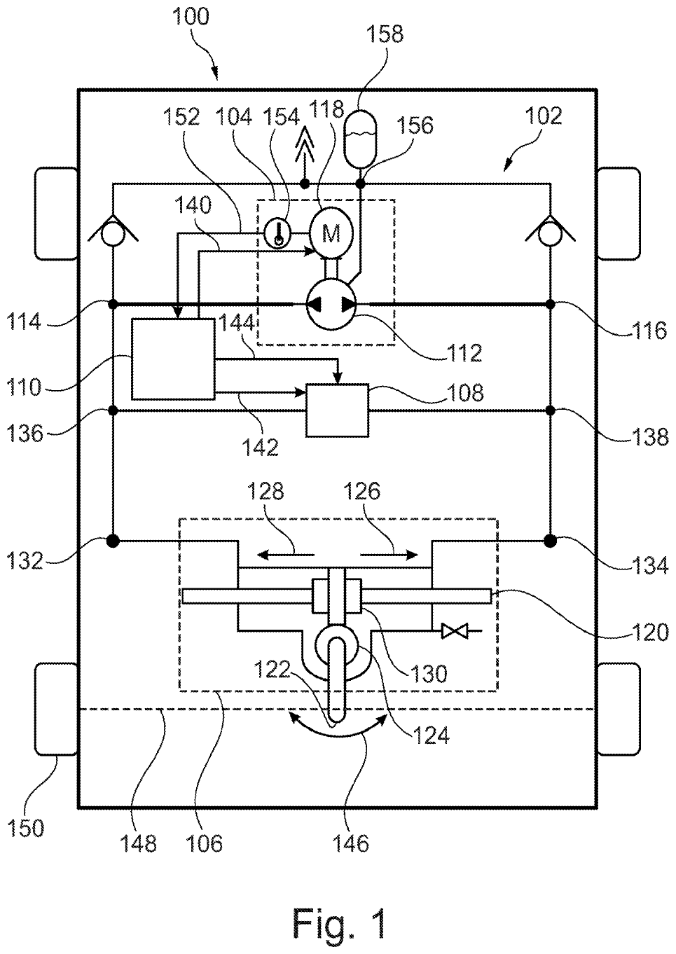

FIG. 1 shows a diagrammatic illustration of a vehicle 100 with a steering apparatus 102 in accordance with one exemplary embodiment. The vehicle 100 can be realized, for example, as a utility vehicle which is configured to mainly transport objects. Since the vehicle 100 can have a weight of several tons, the vehicle 100 has the steering apparatus 102. The steering apparatus 102 is configured to assist a steering operation of an occupant of the vehicle 100 such as, for example, a driver of the vehicle 100. To this end, the steering apparatus 102 has a pump device 104, a transmission device 106, a valve 108 and a control unit 110. Here, the pump device 104 comprises a pump 112 for pumping a working medium to a first output connector 114 or a second output connector 116, a motor which is configured here as an electric motor 118 and is configured to drive the pump 112, and a housing, through which the first output connector 114 and the second output connector 116 are routed and which is arranged around the pump 112 and the electric motor 118. In accordance with this exemplary embodiment, the pump 112 is arranged with the electric motor 118 on a common shaft. In accordance with this exemplary embodiment, the electric motor 118 can be realized as a disk rotor motor. The pump 112 can be realized, for example, as a gear pump.

The transmission device 106 has an input shaft 120 which can be coupled to a steering wheel, and an output shaft 124 which can be coupled to a steering column lever 122. Furthermore, the transmission device 106 has a transmission element 130 which can be moved in a first direction 126 and a second direction 128 in order to transmit a torque from the input shaft 120 to the output shaft 124. Furthermore, the transmission device 106 comprises a first working medium connector 132 and a second working medium connector 134, the first working medium connector 132 being connected to the first output connector 114 in order to move the transmission element 130 with use of the working medium in the first direction 126, and the second working medium connector 134 being connected to the second output connector 116 in order to move the transmission element 130 with use of the working medium in the second direction 128. The valve 108 of the steering apparatus 102 is connected between the first output connector 114 and the second output connector 116. That means that the valve 108 in accordance with this exemplary embodiment has a first valve connector 136 and a second valve connector 138.

In accordance with this exemplary embodiment, the first valve connector 136 is arranged between the first output connector 114 and the first working medium connector 132. In an analogous manner with respect to this, the second valve connector 138 is arranged between the second output connector 116 and the second working medium connector 134 in accordance with this exemplary embodiment. Moreover, the steering apparatus 102 has the control unit 110 which is configured to provide a motor signal 140 to the electric motor 118, in order to operate the electric motor 118 of the steering apparatus 102. The control unit 110 is optionally configured to provide a valve opening signal 142 to the valve 108 in order to open the valve 108 of the steering apparatus 102, and/or to optionally provide a valve closing signal 144 to the valve 108 in order to close the valve 108. This means that the electric motor 118 does not move the steering column lever 122 when the valve 108 is open. Conversely, this means that the valve 108 blocks a throughflow of the working medium through the valve 108 when the valve 108 is closed, with the result that this working medium is pumped through the transmission device 106 in accordance with this exemplary embodiment, and transmits a steering direction 146, predefined by the driver of the vehicle 100, via a steering rod 148 to vehicle wheels 150.

In accordance with this exemplary embodiment, the input shaft 120 is configured to introduce, for example, a torque from a steering column (not shown here) of the vehicle 100, to which the input shaft 120 can be connected or is connected, into the steering apparatus 102. The torque which is introduced via the input shaft 120 can also be called an input torque. In accordance with this exemplary embodiment, the input shaft 120 is connected or mechanically coupled via the steering column of the steering system to a steering wheel (not shown here) of the vehicle 100. The output shaft 124 in accordance with this exemplary embodiment is configured to discharge the torque from the steering apparatus 102 or to output the torque to the steering column lever 122. The torque which is discharged by the output shaft 124 can also be called an output torque or an output force. In accordance with this exemplary embodiment, the transmission element 130 is configured to mechanically transmit the torque from the input shaft 120 to the output shaft 124 and/or to convert the input torque into the output torque.

In accordance with this exemplary embodiment, the control unit 110 can optionally actuate the electric motor 118 in response to a temperature signal 152 which indicates a temperature which lies below a threshold value. In accordance with this exemplary embodiment, the temperature signal 152 is provided to the control unit 110 by a temperature sensor 154 such as, for example, a thermometer. In accordance with this exemplary embodiment, the temperature sensor 154 is realized or can be realized as part of the pump device 104. As an alternative, the temperature sensor 154 can also be arranged in some other place in the vehicle 100. Furthermore, the pump device 104 optionally has an input connector 156, via which the pump device 104 in accordance with this exemplary embodiment is connected to a reservoir vessel 158 for storing the working medium.

In other words, for an application for steering a vehicle 100, a steering apparatus 102 which is also called a steering gear is actuated via a bidirectionally working pump 112, for example a hydraulic pump or a gear pump. The two connectors of the pump 112 are connected to cylinders of a classic known steering gear. The electric gear 118 is connected fixedly to the pump 112, as a result of which the electric motor 118 directly controls the steering of the vehicle 100. It is desirable for precise steering of the vehicle 100 at a relatively high speed for the working medium which exits the pump 112 to be output without pressure or oil quantity variations. Rotational speed variations as a consequence of the detent torque of the electric motor 118 and rotary angle-dependent frictions of the pump 112 are to be minimized here in accordance with this exemplary embodiment.

In order to minimize detent torques of the electric motor 118, various methods have been known up to now which relate, for example, to a shape of the permanent magnets which reduces the natural detent torque, to a specific winding technology of the motor windings, or to specific software. A rotary angle-dependent friction of the pump 112 cannot be compensated for in this way, however.

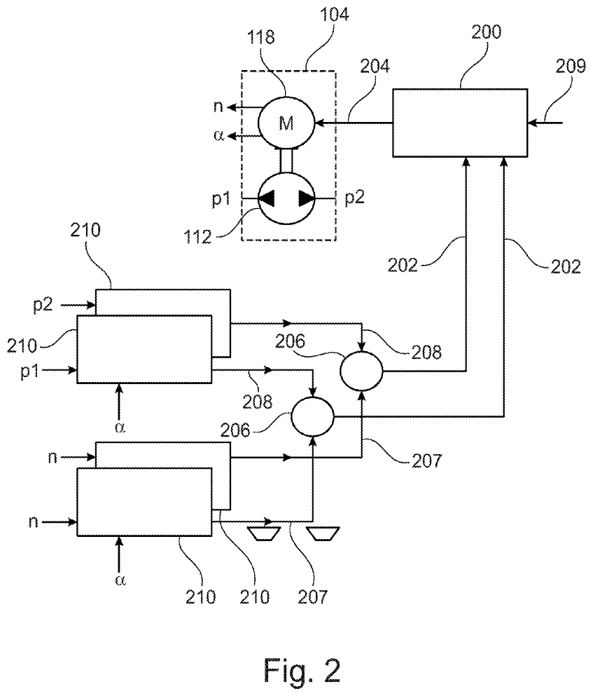

FIG. 2 shows a block circuit diagram of an apparatus 200 for carrying out a method for actuating an electric motor 118 of a pump device 104 of a steering apparatus in accordance with one exemplary embodiment. The pump device 104 which is shown here can correspond to the pump device 104 which is described in FIG. 1. Here too, the pump device 104 has a pump 112 which is configured to pump the working medium which is also called fluid through the steering apparatus. The apparatus 200 is configured to read in a current rotary angle α of the electric motor 118 and a correction value 202 which represents a correlation of an output pressure p1, p2 of the pump device 104 and/or a rotational speed n of the electric motor 118 of the pump device 104 in a manner which is dependent on the rotary angle α of the electric motor 118. The output pressure p1, p2 describes the pressure, output by the pump device 104, of the working medium. Furthermore, the apparatus 200 is configured to output an actuating signal 204 to the electric motor 118 with use of the correction value 202. In accordance with this exemplary embodiment, the output pressure p1 represents right-handed running of the pump 112, and the output pressure p2 represents left-handed running of the pump 112. In accordance with this exemplary embodiment, the correction value 202 is dependent on a rotational direction of the electric motor 118 and/or the pump 112. This means that the correction value 202 is variable for left-handed running and right-handed running. In accordance with this exemplary embodiment, the apparatus 200 is configured to read in the correction value 202, for the determination of which the output pressure pa, p2, dependent on the rotary angle α of the electric motor 118, of the pump device 104 is linked to the rotational speed n of the electric motor 118 which is dependent on the rotary angle α of the electric motor 118, for example in a linking element 206. A rotational speed value 207 and a pressure value 208 are optionally linked to one another, for example, in the linking element 206 in order to determine the correction value 202. As a result of the actuation, in this way, an increase or a decrease of the torque can then be actuated by way of the electric motor 118, with the result that a natural detent torque which results from the design or production of the motor can be compensated for.

Furthermore, the apparatus 200 is optionally configured to output the actuating signal 204 with use of the rotational speed n which represents, for example, a current rotational speed n of the electric motor 118 and/or with use of a setpoint rotational speed 209 of the electric motor 118. In accordance with this exemplary embodiment, the apparatus 200 is configured to read in at least one pressure p1, p2 currently output by the pump device 104 and/or at least one current rotational speed n of the electric motor 118. Furthermore, the apparatus 200 is configured to determine and to store a correction value 202 defined with use of at least the pressure p1, p2 currently output by the pump device 104 and/or the current rotational speed n of the electric motor 118. In accordance with this exemplary embodiment, furthermore, the apparatus 200 is configured to read in a plurality of pressure values p1, p2 output by the pump device 104 and/or a plurality of rotational speed values n of the electric motor 118, and to determine the correction value 202 with use of averaging and/or low pass filtering of the pressure values p1, p2 and/or to determine a plurality of rotational speed values n of the electric motor 118. Here, for example, the correction value 202 is defined from at least one characteristic diagram 210, in which a correlation of the output pressure p1, p2 of the pump device 104 and/or the rotational speed n of the electric motor 118 of the pump device 104 is mapped in a manner which is dependent on a plurality of rotary angles α of the electric motor 118. In accordance with one exemplary embodiment, for example, the characteristic diagrams 210 are stored in a storage device which has, for example, the linking element 206 and provides the correction value 202 to the apparatus 200, for example by means of correction signal.

In other words, a possibility is provided to eliminate or at least to minimize a detent torque in a steering apparatus which is also called a steering gear, since, for example in the case of an otherwise constant actuation of the electric motor 118, variations are formed with regard to rotational speed n and pressure p1 in the case of right-handed running, or p2 in the case of left-handed running of the electric motor 118. Variations of this type over the rotary angle α are caused, for example, by way of the detent torque of the electric motor 118 and by way of rotary angle-dependent variations in the friction of the pump 112. Here, in accordance with this exemplary embodiment, the values are stored in a plurality of rotary angle-dependent characteristic diagrams 210 which output the correction value 202 with regard to an output power of a motor output stage in a manner which is dependent on the pressure and the rotational speed.

Since, in particular, the rotational speed-dependent friction of the pump 112 can also vary in a rotational direction-dependent manner, characteristic diagrams 210 which are separate depending on the rotational direction are created. Here, a delay time in the characteristic diagram 210 has already been taken into consideration in a manner which is dependent on the rotational speed n and its running direction. This means a time period which the electric motor 118 requires, for example, in order to reach the corresponding rotational speed n. In accordance with one alternative exemplary embodiment, greater adhesion and friction values of the pump 112 or of the pump start are stored at the characteristic diagram addresses with, for example, a rotational speed of 0 rpm.

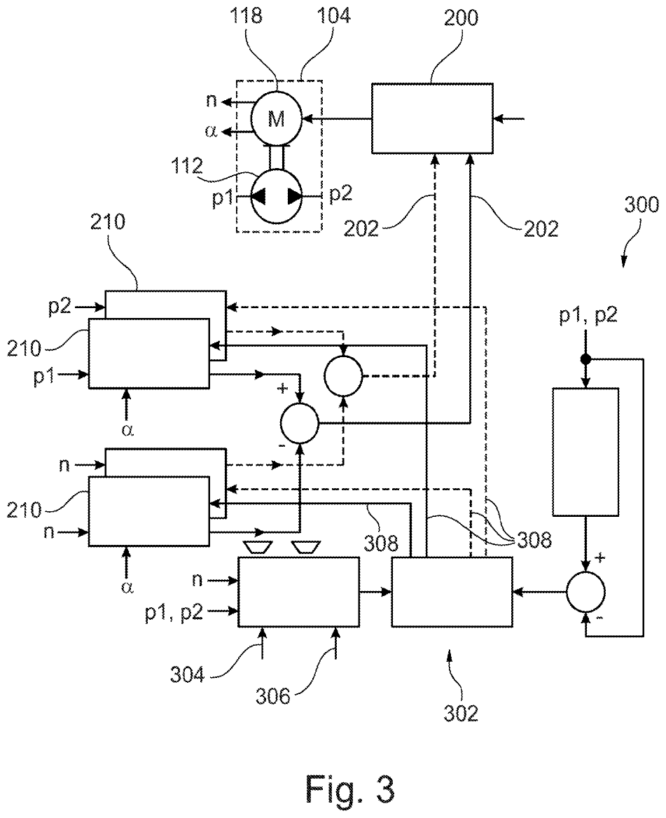

FIG. 3 shows a block circuit diagram of an apparatus 200 for carrying out a method for actuating an electric motor 118 of a pump device 108 of a steering apparatus in accordance with one exemplary embodiment. This can be an exemplary embodiment of the apparatus 200 described on the basis of FIG. 2. In accordance with this exemplary embodiment, however, the block circuit diagram is of extended illustration, with the result that the apparatus 200 in accordance with this exemplary embodiment is configured to read in a plurality of pressure values 208 output by the pump device 104 and/or a plurality of rotational speed values 207 of the electric motor 118, and to determine the correction value 202 with use of averaging and/or low pass filtering 300 of the pressure values p1, p2 and/or a plurality of rotational speed values n of the electric motor 118.

Furthermore, the apparatus 200 is configured to carry out a method for providing the correction value 202 for correcting a variation in the rotational speed n and/or the output pressure p1, p2 of the pump device 104. In this regard, the apparatus 200 is configured to read in the rotary angle α of the electric motor 118 of the pump device 104 and at least one pressure p1, p2 assigned to the rotary angle α and output by the pump device 104 and/or at least one rotational speed n, assigned to the rotary angle α, of the electric motor 118. Furthermore, the apparatus 200 is configured to determine and to store the associated pressure p1, p2 with use of the rotary angle α which is assigned to the pressure p1, p2, and/or with use of the correction value 202 defined by rotational speed n, assigned to the rotary angle α, of the electric motor 118. In accordance with this exemplary embodiment, the apparatus 200 is configured to read in not only one, but rather a plurality of pressure values each assigned to a rotary angle α and/or a plurality of rotational speed values, each assigned to a rotary angle α, of the electric motor 118, and to determine the correction value 202 with use of averaging of the pressure values which are assigned to the respective rotary angles α and/or the rotational speed values, which are assigned to the respective rotary angles α, of the electric motor. Here, for example, the apparatus 200 defines a characteristic diagram 210, in which a correction value 202 is mapped as correlation of an output pressure p1, p2 of the pump device 104 and/or a rotational speed n of the electric motor 118 of the pump device 104 in a manner which is dependent on in each case one rotary angle α of the electric motor 118. In accordance with this exemplary embodiment, for example, this can be carried out in a learning mode 302, in which, in accordance with this exemplary embodiment, the correction values 202 are adapted dynamically within the characteristic diagrams 210 in an operating state, since, for example, the friction values of the pump 112 can change as a result of ageing, for example.

In accordance with this exemplary embodiment, a rotational speed n and a pressure value p1, p2 are fed in in a learning phase which optionally takes place in the case of a detection of an end of the conveyor belt 304 at the factory. For example, a temperature 306 of the working medium is optionally fed in. In the case of subsequent determining of the correction value 202, for example, the data which are fed in in the learning mode 302 are used as basis.

Functions in the learning mode 302 during an end of the conveyor belt are optionally formed, for example, during a functional test in the factory by means of storing of all the created correction characteristic diagrams and determining of an average value. In accordance with this exemplary embodiment, this average value serves as a starting value for the characteristic diagrams 210. In accordance with this exemplary embodiment, the pumps 112 which have already been assembled including electric motor 118 are measured on a function test bench, and all the characteristic diagram points are moved to one after another. Here, a low pass by means of low pass filtering 300 forms the respective average value of the pressures p1, p2, the respectively current pressure value being used as characteristic variable for the correction of the current characteristic diagram point. During the operation, the friction values of the pump 112 can change as a result of ageing, for example. Therefore, in accordance with this exemplary embodiment, it is helpful for characteristic diagram values 308 to be adapted in the characteristic diagrams 210 even during operation. In this regard, a learning detection means optionally monitors whether the electric motor 118 remains at a constant operating point over several revolutions. If this is fulfilled, the learning mode 302 evaluates the current pressure difference in relation to its average value in accordance with this exemplary embodiment, and corrects the current characteristic diagram value correspondingly.

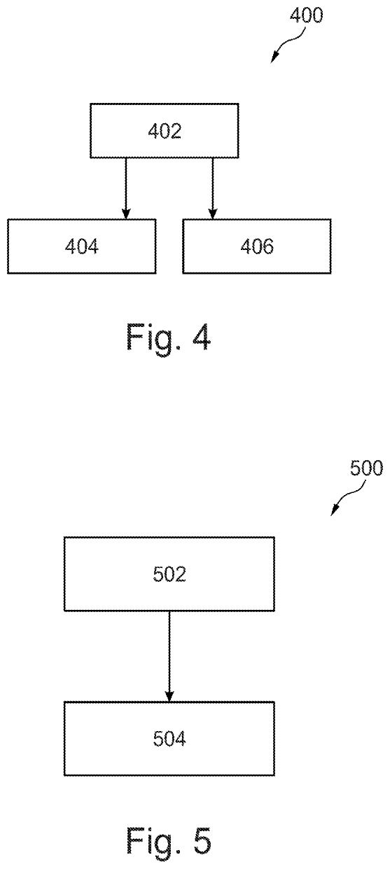

FIG. 4 shows a flow chart of a method 400 for actuating an electric motor of a pump device of a steering apparatus in accordance with one exemplary embodiment. The method 400 can be actuated or carried out, for example, by an apparatus as has been described in FIG. 2 or 3. Here, the method 400 comprises a step 402 of reading in a current rotary angle of the electric motor of the pump device and a correction value which represents a correlation of an output pressure of the pump device and/or a rotational speed of the electric motor of the pump device in a manner which is dependent on the rotary angle of the electric motor. Furthermore, the method 400 comprises a step 404 of outputting an actuating signal to the electric motor with use of the correction value. The method 400 optionally comprises a step 406 of determining and storing, in order to determine and to store the correction value defined with use of at least the pressure output currently by the pump device and/or the current rotational speed of the electric motor.

FIG. 5 shows a flow chart of a method 500 for providing a correction value for correcting a variation in a rotational speed and/or an output pressure of a pump device of a steering apparatus in accordance with one exemplary embodiment. The method 500 can be carried out or actuated, for example, by an apparatus as has been described in either of FIG. 2 or 3. Here, the method 500 comprises a step 502 of reading in and a step 504 of determining and storing. In the step 502 of reading in, a rotary angle of the electric motor of the pump device and at least one pressure which is assigned to the rotary angle and is output by the pump device and/or at least one rotational speed, assigned to the rotary angle, of the electric motor are read in. In the step 504 of determining and storing, a correction value which is defined with use of at least the pressure assigned to the rotary angle and/or the rotational speed, assigned to the rotary angle, of the electric motor is determined and stored.

The method steps presented here can be carried out repeatedly or in a different sequence to that described.

If one exemplary embodiment comprises an “and/or” link between a first feature and a second feature, this is to be interpreted such that the exemplary embodiment in accordance with one embodiment has both the first feature and the second feature, and in accordance with a further embodiment has either only the first feature or only the second feature.

### LIST OF DESIGNATIONS

100 Vehicle
102 Steering apparatus
104 Pump device
106 Transmission device
108 Valve
110 Control unit
112 Pump
114 First output connector
116 Second output connector
118 Electric motor
120 Input shaft
122 Steering column lever
124 Output shaft
126 First direction
128 Second direction
130 Transmission element
132 First working medium connector
134 Second working medium connector
136 First valve connector
138 Second valve connector
140 Motor signal
142 Valve opening signal
144 Valve closing signal
146 Steering direction
148 Steering rod
150 Vehicle wheels
152 Temperature signal
154 Temperature sensor
156 Input connector
158 Reservoir vessel
200 Apparatus
202 Correction value
204 Actuating signal
206 Linking element
207 Rotational speed value
208 Pressure value
210 Characteristic diagram
p1, p2 Output pressure
n Rotational speed
α Rotary angle
300 Low pass filtering
302 Learning mode
304 End of the conveyor belt
306 Temperature
308 Characteristic diagram values
400 Method for actuating an electric motor of a pump device of a steering apparatus
402 Step of reading in
404 Step of outputting
406 Step of determining and storing
500 Method for providing a correction value for correcting a variation in a rotational speed and/or an output pressure of a pump device of a steering apparatus
502 Step of reading in
504 Step of determining and storing

1.-15. (canceled)

16. A method for actuating an electric motor of a pump device of a steering apparatus, the method comprising:
(a) reading-in a current rotary angle (α) of the electric motor of the pump device and a correction value which represents a correlation of an output pressure (p1, p2) of the pump device and/or a rotational speed (n) of the electric motor of the pump device in a manner which is dependent on the rotary angle (α) of the electric motor; and
(b) outputting an actuating signal to the electric motor with use of the correction value.

17. The method as claimed in claim 16, wherein
the correction value read-in in step (a) is dependent on a rotational direction of the electric motor and/or a pump of the pump device.

18. The method as claimed in claim 17, wherein
the correction value read-in in step (a), for the determination of which correction value the output pressure (p1, p2), dependent on the rotary angle (α) of the electric motor, of the pump device is linked to the rotational speed (n), dependent on the rotary angle (α) of the electric motor, of the electric motor of the pump device

19. The method as claimed in claim 18, wherein
the actuating signal is output in step (b) with use of the current rotational speed (n) of the electric motor and/or a setpoint rotational speed of the electric motor.

20. The method as claimed in claim 19, wherein
at least the one pressure (p1, p2) which is output currently by the pump device and/or at least the one current rotational speed (n) of the electric motor, is further read-in in step (a), and the correction value which is defined with use at least of the pressure (p1, p2) currently output by the pump device and/or the current rotational speed (n) of the electric motor, is determined and stored in a step (c) of determining and storing in order to be provided for a following step of reading-in.

21. The method as claimed in claim 20, wherein
a plurality of pressure values are output by the pump device and/or a plurality of rotational speed values of the electric motor are read-in in step (a), and
in step (c), the correction value is determined with use of averaging and/or low pass filtering of the plurality of pressure values and/or with use of the plurality of rotational speed values of the electric motor.

22. The method as claimed in claim 21, wherein
the correction value read-in in step (a) is defined from at least one characteristic diagram, in which a correlation of the output pressure (p1, p2) of the pump device and/or the rotational speed (n) of the electric motor of the pump device is mapped in a manner dependent on a plurality of rotary angles (a) of the electric motor.

23. A method for providing a correction value for correcting a variation in a rotational speed (n) and/or an output pressure (p1, p2) of a pump device of a steering apparatus, the method comprising:
(a) reading-in a rotary angle (α) of the electric motor of the pump device and at least one pressure (p1, p2) which is assigned to the rotary angle (α) and is output by the pumping device, and/or at least one rotational speed (n), assigned to the rotary angle (α), of the electric motor; and
(b) determining and storing a correction value which is defined with use of at least the at least one pressure (p1, p2) which is assigned to the rotary angle (α) and/or the rotational speed (n), assigned to the rotary angle (α), of the electric motor.

24. The method as claimed in claim 23, wherein
a plurality of pressure values assigned to in each case one rotary angle (α) and/or a plurality of rotational speed values assigned to in each case one rotary angle (α), of the electric motor are read-in in step (a), and the correction value is determined in step (b) with use of averaging and/or low pass filtering of the plurality of pressure values and/or the plurality of rotational speed values.

25. The method as claimed in claim 24, wherein
at least one characteristic diagram is defined in step (b), in which characteristic diagram a correction value is mapped as correlation of an output pressure (p1, p2) of the pump device and/or a rotational speed (n) of the electric motor of the pump device in a manner which is dependent on in each case one rotary angle (α) of the electric motor.

26. A computer product comprising a non-transitory computer readable medium having stored thereon program code which, when executed by one or more processors, carries out the acts of:
(a) reading-in a current rotary angle (α) of an electric motor of a pump device and a correction value which represents a correlation of an output pressure (p1, p2) of the pump device and/or a rotational speed (n) of the electric motor of the pump device in a manner which is dependent on the rotary angle (α) of the electric motor; and
(b) outputting an actuating signal to the electric motor with use of the correction value.

27. A steering apparatus for a vehicle, comprising:
a pump device which has a pump for pumping a working medium to a first output connector or, as an alternative, a second output connector, an electric motor for driving the pump, and a housing, through which the first output connector and the second output connector are routed and which is arranged around the pump and the electric motor;
a transmission with an input shaft which is couplable to a steering wheel and with an output shaft which is couplable to a steering column lever, a transmission element which is movable in a first direction and a second direction in order to transmit a torque from the input shaft to the output shaft, and a first working medium connector and a second working medium connector, the first working medium connector being connected to the first output connector in order to move the transmission element with use of the working medium in the first direction, and the second working medium connector being connected to the second output connector in order to move the transmission element with use of the working medium in the second direction; and
a control unit configured to:
provide a motor signal to the electric motor, in order to operate the electric motor of the steering apparatus,
wherein the control unit is further configured to:
(a) read-in a current rotary angle (α) of the electric motor of the pump device and a correction value which represents a correlation of an output pressure (p1, p2) of the pump device and/or a rotational speed (n) of the electric motor of the pump device in a manner which is dependent on the rotary angle (α) of the electric motor; and
(b) output an actuating signal to the electric motor with use of the correction value.

28. The steering apparatus as claimed in claim 27, further comprising:
a valve which is connected between the first output connector and the second output connector.
